(19) United States
(12) Patent Application Publication
(10) Pub. No.: US 2022/0401824 A1
(43) Pub. Date: Dec. 22, 2022

(54) Letter-Based Lottery System

(71) Applicant: Scott Tomeske, Lyndhurst, NJ (US)

(72) Inventor: Scott Tomeske, Lyndhurst, NJ (US)

(21) Appl. No.: 17/351,358

(22) Filed: Jun. 18, 2021

(51) Int. Cl. A63F 3/06; G07F 17/32

(52) U.S. Cl. CPC A63F 3/0605; G07F 17/3258; G07F 17/329

(57) ABSTRACT

This present invention relates to a symbol-based or letter-based lottery game system. The novel letter-based lottery game allows users to play a lottery using a set of letters that allows the odds to be different than that of a conventional number-based lottery game as the number of unique letters is more than the standard ten numerical single digits. The users are given a ticket having a set of three or more letters and the user with the winning ticket having all matching letters in the same order as the drawn set of letters wins the maximum prize. A plurality of prizes or awards for matching of a subset of the set of drawn letters is also awarded to a plurality of users. The present invention letter-based lottery game can be played using a wild-card and can also select different number of letters based on wager amount.

### FIELD OF THE INVENTION

The present invention relates generally to the field of lottery games. More specifically, the present invention relates to a unique lottery system featuring the use of non-numeric or alphabetical letters instead of numbers. The letter-based lottery system provides for odds of winning that are vastly different from that of a conventional lottery system that utilizes numbers. The novel letter-based lottery system may include additional ways to win, for instance, the spelling of a particular word, or the inclusion of a wild-card ball that can be used in place of any letter if drawn, etc. The unique lottery system of the present invention provides a novel and fun-filled method of playing lottery games, thus keeping the users entertained. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various lottery games are well known in the art. People from various countries around the world play lottery games and try their luck to win prizes. Typically, a lottery game is a type of gambling that involves users purchasing tickets with a set of numbers printed thereon. Next, the person running the lottery selects or draws a predetermined number of balls at random, each having a number printed on them. The goal is to then match the numbers drawn to those numbers appearing on the user's ticket. The users can buy a lottery ticket having a set of numbers that is either computer-generated at random or is selected by the user at the time of purchasing of lottery ticket. When the lottery numbers are drawn, a prize such as cash or goods is assigned to the user whose lottery ticket number matches the randomly chosen numbers from the lottery drawing.

Generally, numbers are used in the lottery tickets for generating a random unique number for each user. However, the unique number digits are limited, and therefore, lead to a smaller number of unique random combinations. Some lotteries are based on matching a winning permutation, where the order of the matched numbers must be the same as the winning set of numbers. Other lotteries are based on matching a winning combination, where the order of the matched numbers does not matter, thus leading to more chances to win. Further, some lotteries select the winning set of numbers by drawing the entire set of numbers from one bin. This is commonly referred to as a non-repeating selection method, since the same number cannot be drawn more than once. Other lotteries select the winning set of numbers by drawing the each of numbers from a separate bin that contains all of the available numbers. This is commonly referred to as a repeating selection method, since the same number can be drawn more than once. The odds of winning are different between the repeating and non-repeating selection methods.

For instance, three numbers drawn at random using a repeating selection method with separate bins containing numbers between 0 and 9 will generate 1000 possible permutations ranging between 000 and 999. In this case, a user would have 1 chance out of 1000 to match all three numbers in the same order. However, if the winning the lottery was based on combinations instead of permutations, the user would have 1 chance out of 220 of winning when the numbers can be in any order (e.g., 123, 132, 213, 231, 312, and 321).

If the three numbers were replaced by a non-numeric symbol such as the letters of the alphabet (26 letters), the novel letter-based lottery system would now generate 17,576 possible permutations ranging between AAA and ZZZ, or 3,276 unique 3-letter combinations. Additionally, the conventional number-based lottery games have become boring for the users. The conventional lottery games usually comprise of matching the set of numbers that are printed on a lottery ticket to the set of randomly drawn numbers, and no other features are currently added to these games, which can be enjoyed by the users or can add to the prize money of the users. With time, people lose their interest in the typical lottery games.

In the current lottery games, since there are a smaller number of permutations, a smaller number of uniquely numbered tickets are available for purchase. Many people interested in the game may be left behind as the random selection get quickly exhausted and may have to wait for the next lottery game. Alternatively, the increased possible permutations and combinations in the letter-based lottery system of the present invention can provide larger cash prizes since more tickets can be sold.

Therefore, there exists a long felt need in the art for a unique letter-based lottery system whereby a significantly larger number of ticket permutations exist, thus allowing many more users to participate in the novel letter-based lottery system. There is also a long felt need in the art for a lottery game that eliminates the need to wait for the next lottery game and allows many more people to purchase tickets in the lottery game. Additionally, there is a long felt need in the art for a lottery game that keeps the users entertained. Moreover, there is a long felt need in the art for a lottery game that is symbols-based or letter-based instead of number-based, thus having a significantly larger number of permutations and combinations, thereby allowing for a greater number of users to participate in the game. Further, there is a long felt need in the art for a lottery game that includes additional ways to win other than having to match all of the drawn numbers, thus leading to increased entertainment for the users. Finally, there is a long felt need in the art for a lottery game that allows more people to participate, keeps the users entertained, provides more opportunities of winning additional prizes, and can be easily played.

The subject matter disclosed and claimed herein, in one embodiment thereof, comprises a method for playing a letter-based lottery game in which the set of non-numeric symbols or alphabetical letters are printed onto a user's ticket in exchange for some monetary amount from the user, each set of printed symbols/letters comprising a set of three or more symbols/letters that are either selected by the user or computer-generated randomly, drawing a winning set of symbols/letters, comparing the winning set of symbols/letters to the printed set found on each of the user's tickets, and rewarding the user having the ticket that has the same set of symbols/letters as that of the winning set of symbols/letters. Based on the matching level of subset of symbols/letters that are on a user's lottery with the winning set of symbols/letters, some prizes are also awarded to one or more additional users. The prize amount paid to the winning user is given as per the rules of the novel letter-based lottery system.

In this manner, the novel letter-based lottery system of the present invention accomplishes all of the forgoing objectives, and provides a relatively easy, convenient and entertaining solution for the individuals playing lottery games, which features significantly more unique permutations/combinations and therefore allows for significantly more available tickets to be sold to users who wish to play the game. The letter-based lottery system of the present invention features multiple ways to win, which allows the participants to win additional prizes.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for playing the letter-based lottery system comprising the steps of requesting one or more lottery tickets from either a smartphone application or a lottery terminal, printing a lottery ticket for a user whereby each printed ticket comprises a set of three or more non-numeric symbols or alphabetic letters that are either selected by the user or randomly generated at the time of the ticket purchase, distributing the lottery ticket to the user usually through a purchase transaction, drawing a winning set of symbols/letters from a plurality of bins each of which contain a set of all the symbols/letters (i.e., letters A through Z), comparing the winning set of symbols/letters to the set of symbols/letters that are printed on each user's ticket, and awarding the user having the ticket with the matching set of symbols/letters. In addition, based on the matching level of subset the winning set (e.g., matching only three of the five letters drawn instead of matching all five letters drawn), additional prizes may be awarded to one or more users. The prizes awarded to the users are given as per the rules of the novel letter-based lottery system. Additionally, the letter-based lottery system could proceed as described above with only one bin of symbols/letters for drawing, thereby altering the total number of available permutations and combinations since no set of symbol s/letters could contained repeated symbol s/letters.

In a further embodiment of the present invention, a method of playing a letter-based lottery game is disclosed and comprising the steps of distributing tickets containing a randomly generated set of three or more letters to each user, generating a random winning set of letters, comparing the set of letters on each printed ticket to the winning set of letters, awarding the user having the ticket that has the same set of letters as the winning set of letters. A user having a ticket containing a matching three or four-letter word or letter combination to that of the winning combination could also be awarded prizes, whereby a plurality of tickets may be generated to include a winning combination of letters.

In yet a further embodiment of the present invention, the award value depends on the wager value of the user who wins the lottery by having the ticket that contains the winning set of letters. A user may purchase one or more lottery tickets each having a different set of non-numeric symbols or alphabetic letters. The non-numeric symbols or alphabetic letters may be of English language or non-English language.

The number of symbols in each set that are printed onto a ticket may vary depending on the type of the lottery game selected by the user. Preferably, the letter-based lottery system of the present invention may include games having between three to six letters printed on each ticket. Further, using the English alphabet, the number of possible letters is 26 (i.e., A through Z), however, other sets of symbols or non-English alphabets could be used as well. The prize amounts may also depend on the wager amount of the user placed when the ticket was purchased and/or the specific lottery game rules. The set of letters generated on each ticket may either be selected by the users at the time of ticket purchase or may be randomly generated by the lottery server computer at the time of the ticket purchase. The set of letters on each printed ticket may include a string of random letters, consecutive letters of the alphabet, or words commonly found in the English language. For instance, there are approximately 1,065 three-letter words in the English language. A letter-based lottery system of the present invention having three separate letters drawn, based on the 26 letters in the English alphabet, would generate 17,576 3-letter permutations, where individual letters may be repeated. A version of the novel letter-based lotter system may award prizes based on the user receiving a lottery ticket with a printed set of letters that spells an actual word found in the English dictionary. In this example, a user may have 1,065 chances to win out of 17,576 possible tickets, whereby each ticket contains a unique set of letters.

The letter-based lottery system of the present invention creates a non-numeric symbols-based lottery game that provides different odds of winning in comparison to a conventional number-based lottery game. The users may select three or more letters and may be awarded prizes for matching a subset of the total winning set of letters. In one embodiment, to increase the chances of winning, a wild-card letter may be randomly assigned to a player that can be assumed as any letter, thus increasing the chances of winning.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of the letter-based lottery system of the present invention as per the disclosed architecture;

FIG. 2 illustrates an exemplary set of three letters assigned to a user in a letter-based lottery for playing one embodiment of the letter-based lottery game of the present invention in accordance with the disclosed architecture;

FIG. 3 illustrates a flow diagram showing the steps needed to create a set of letters for a user to play one potential embodiment of the letter-based lottery game of the present invention in accordance with the disclosed architecture;

FIG. 4 illustrates a flow diagram showing the routine steps of one potential embodiment of the letter-based lottery game of the present invention in accordance with the disclosed architecture;

FIG. 5 illustrates an exemplary set of five letters assigned to a user in one potential embodiment of the letter-based lottery game of the present invention in accordance with the disclosed architecture;

FIG. 6 illustrates an exemplary letter-based lottery ticket assigned to a user for while playing one potential embodiment of the letter-based lottery game of the present invention in accordance with the disclosed architecture; and

FIG. 7 illustrates a plurality of exemplary ways of winning one potential embodiment of the letter-based lottery game of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a unique letter-based lottery system whereby a significantly larger number of ticket permutations exist, thus allowing many more users to participate in the novel letter-based lottery system. There is also a long felt need in the art for a lottery game that eliminates the need to wait for the next lottery game and allows many more people to purchase tickets in the lottery game. Additionally, there is a long felt need in the art for a lottery game that keeps the users entertained. Moreover, there is a long felt need in the art for a lottery game that is symbols-based or letter-based instead of number-based, thus having a significantly larger number of permutations and combinations, thereby allowing for a greater number of users to participate in the game. Further, there is a long felt need in the art for a lottery game that includes additional ways to win other than having to match all of the drawn numbers, thus leading to increased entertainment for the users. Finally, there is a long felt need in the art for a lottery game that allows more people to participate, keeps the users entertained, provides more opportunities of winning additional prizes, and can be easily played.

The present invention, in one exemplary embodiment, comprises a method for playing a letter-based lottery game in which the set of non-numeric symbols or alphabetical letters are printed onto a user's ticket in exchange for some monetary amount from the user, each set of printed symbols/letters comprising a set of three or more symbols/letters that are either selected by the user or computer-generated randomly, drawing a winning set of symbols/letters, comparing the winning set of symbols/letters to the printed set found on each of the user's tickets, and rewarding the user having the ticket that has the same set of symbols/letters as that of the winning set of symbols/letters. Based on the matching level of subset of symbols/letters that are on a user's lottery with the winning set of symbols/letters, some prizes are also awarded to one or more additional users. The prize amount paid to the winning user is given as per the rules of the novel letter-based lottery system.

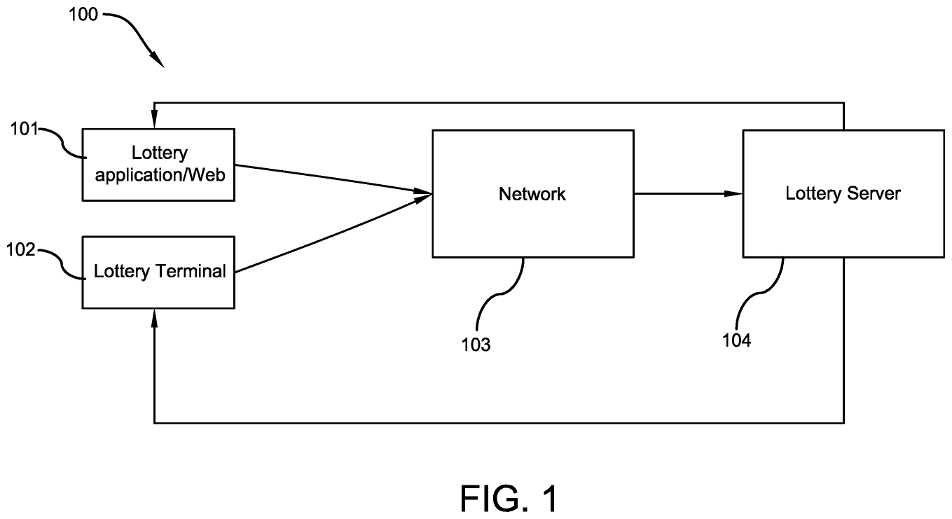

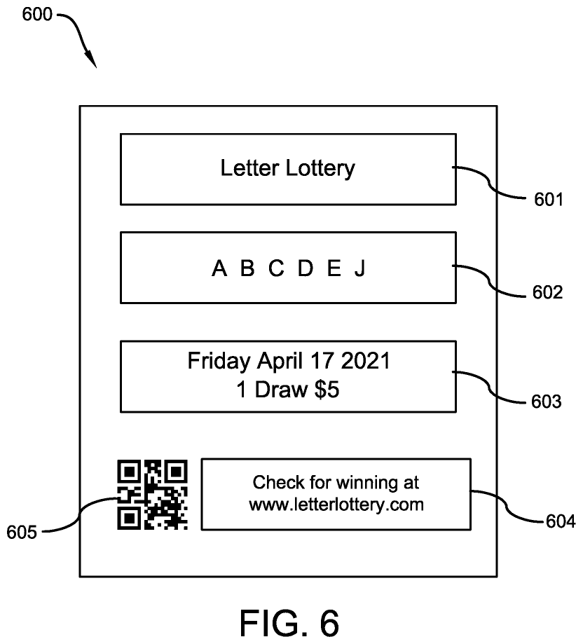

Referring initially to the drawings, FIG. 1 illustrates a schematic view of one potential embodiment of the letter-based lottery system or game 100 of the present invention as per the disclosed architecture. As shown, the letter-based lottery game 100 of the present invention has a lottery server 104 that generates either an electronic or physical lottery ticket 600, as further described in FIG. 6. The lottery server 104 of the novel letter-based lottery system 100 is similar to a conventional lottery server having computing capabilities, storage for a database for securing user information, along with other common computing functions. The lottery server 104 may have a coupled payment gateway to allow users to make payment for the purchased lottery tickets. The lottery server 104 is connected to a network 103 such as the Internet and can be accessed through the user interface or a smartphone application 101 by a user to buy lottery tickets.

Lottery terminals 102 are also connected to the lottery server 104 through the network 103. A plurality of lottery terminals 102 of the letter-based lottery system 100 are located in convenience stores, drug stores, gas stations, and other places where conventional lottery terminals are commonly placed. Users can purchase lottery tickets 600 either through the smartphone application 101 or the at the lottery terminal 102.

The lottery terminals 102 and the lottery server 104 may communicate over a network 103 such as the Internet. All communication between the lottery server 104, the lottery smartphone application 101, and the lottery terminal 102 is secure and encrypted, thus keeping the payment information of the users remain secured.

The lottery server 104 and the lottery terminals 102 may include memory for storing lottery programs and routines, a microprocessor for executing the stored programs. The microprocessor, memory, and the Input-Output bus may be directly connected via dedicated communications lines to the network depending on the needs of the letter-based lottery system 100.

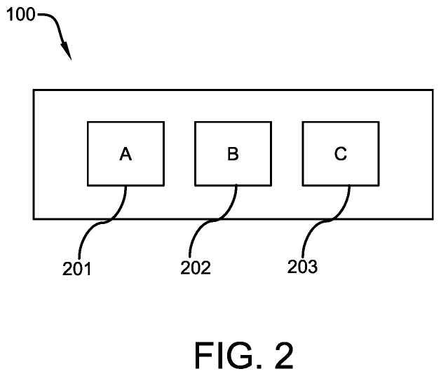

FIG. 2 illustrates an exemplary set of three letters assigned to a user in a letter-based lottery for playing one embodiment of the letter-based lottery game 100 of the present invention in accordance with the disclosed architecture. In the letter-based lottery system 100 of the present invention, a user's set of three letters 200 is generated and printed onto the user's ticket 600. The user's set of three letters 200 can either be selected by the user or generated randomly by the lottery server 104 at the time of the ticket purchase. When making their selection, the user may have the option of choosing the specific letters and the order of the letters for the user's set of three letters 200. Otherwise, the lottery server 104 will generate the specific letters and the order of the three letters 200. In the present embodiment, the letter-based lottery system 100 is configured to use a set of three letters as shown on the user's ticket. As shown in FIG. 2, the user's ticket includes the user's set of three letters 200 where the first letter 201 is “A”, the second letter 202 is “B”, and the third letter 203 is “C”.

The lottery ticket of the present invention is distributed to the user once a bet or wager amount is paid by the user to the lottery server 104. The user's set of three letters 200 is printed onto the lottery ticket, which may also include additional information such as instructional or security information such as game eligibility and rules information, a bar code, prize details, ticket serial number, or any other desired information.

It should be appreciated that since the number of permutations and combinations of the novel letter-based lottery system 100 is significantly more than the conventional numbers-based lottery system, the odds of winning the letter-based lottery game 100 is significantly different from that of the conventional numbers-based lottery system. Also, it should be noted that although in the present embodiment, the number of letters in each of the letter sets is three, other letter-based lottery games 100 can include four letters, five letters or six letters.

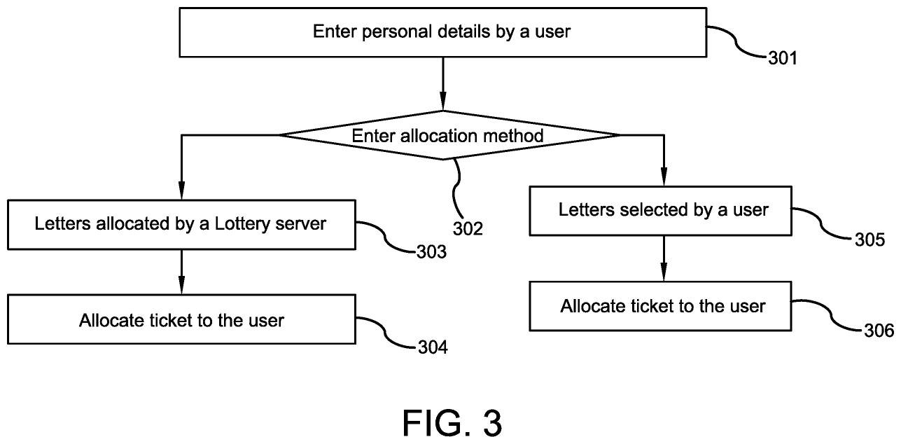

FIG. 3 illustrates a flow diagram showing the steps needed to create a set of letters for a user to play one potential embodiment of the letter-based lottery game 100 of the present invention in accordance with the disclosed architecture. More specifically, a user may initiate the selection process of the user's set of letters 200 by entering personal details 301 either by using the lottery application 101 on their smartphone, or by using a lottery terminal 102. Next, the letter allocation method 302 is selected. If the user does not want to select their own letters, the letter allocation method 302 is set to letter allocation by server 303, which then instructs the lottery server 104 to randomly generate a user's set of letters 200. The novel letter-based lottery system 100 can now allocate ticket to user 304.

If the user wants to select their own letters, the letter allocation method 302 is set to letter allocation by user 305, which then instructs the lottery server 104 to generate a user's set of letters 200 using the letters requested by the user. The novel letter-based lottery system 100 can now allocate ticket to user 306.

The novel letter-based lottery ticket containing the user's set of letters 200 is now eligible to be played for a particular game and a wager amount, which can also be included on the lottery ticket. The letter-based lottery system 100 may include either a printed ticket or an electronic ticket and can be used to claim the price or the award of the lottery. The prizes may be collected at any of the lottery terminal 102 locations, as well as, other designated locations.

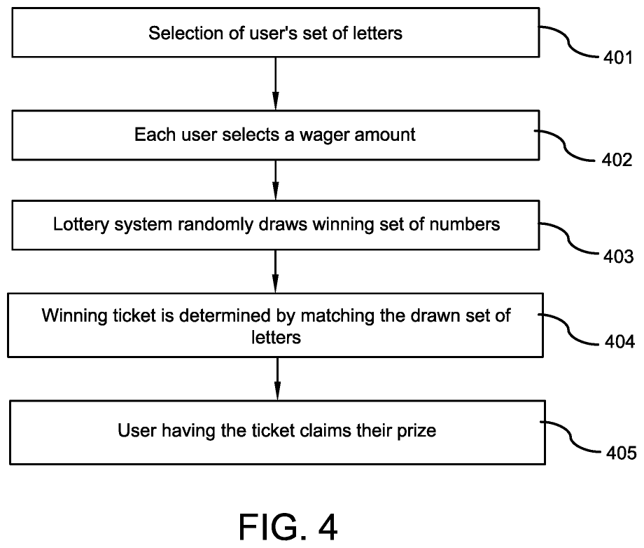

FIG. 4 illustrates a flow diagram showing the routine steps of one potential embodiment of the letter-based lottery game 100 of the present invention in accordance with the disclosed architecture. More specifically, as an initial step, a set of predetermined number of letters is allocated to each user of the novel letter-based lottery game (Block 401). The user's set of letters is either randomly generated or is selected by the user from a given set of letters or non-numeric symbols. Next, each user selects a wager amount and the type of a game for the lottery ticket (Block 402). It should be appreciated that the steps 401 and 402 may be interchanged as well. Then, whenever all of the eligible tickets are allotted to users or on a predetermined time and date, the letter-based lottery system can draw the winning set of letters (Block 403). The drawing process (Block 403) can either be performed manually by selecting letters from bins or be computer generated. The lottery ticket that includes the same letter set as that of the drawn winning letter set is the winning lottery ticket (Block 404). The user having the winning ticket, turns the winning ticket in to the place of purchase or some other designated location to claim their prize (Block 405).

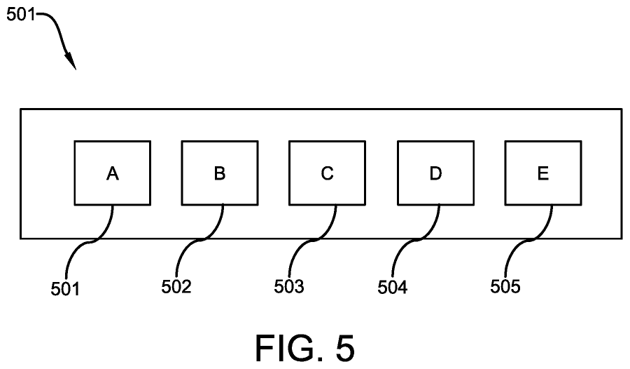

FIG. 5 illustrates an exemplary set of five letters assigned to a user in one potential embodiment of the letter-based lottery game 100 of the present invention in accordance with the disclosed architecture. More specifically, in the letter-based lottery system 100 of the present invention, a user's set of five letters 500 is generated and printed onto the user's ticket 600. The user's set of five letters 500 can either be selected by the user or generated randomly by the lottery server 104 at the time of the ticket purchase. When making their selection, the user may have the option of choosing the specific letters and the order of the letters for the user's set of five letters 500. Otherwise, the lottery server 104 will generate the specific letters and the order of the five letters 500. In the present embodiment, the letter-based lottery system 100 is configured to use a set of five letters as shown on the user's ticket. As best shown in FIG. 5, the user's ticket includes the user's set of five letters 500 where the first letter 501 is “A”, the second letter 502 is “B”, the third letter 503 is “C”, the forth letter 504 is “D”, and the fifth letter is “E”.

A wild-card letter may be included as part of the drawn winning letter set or as part of the randomly generated user's set of five letters. In either case, the wild-card letter will allow more chances to win since it does not have to match the corresponding letter when matching the drawn winning letter set to the user's set of letters. This too, can be applied to any letter-based lottery system of the present invention having three, four, five, six, or more letters in each set of letters.

FIG. 6 illustrates an exemplary letter-based lottery ticket assigned to a user for while playing one potential embodiment of the letter-based lottery game 100 of the present invention in accordance with the disclosed architecture. More specifically, the lottery ticket 600 includes the user's set of letters 602, which forms the basis of determining the winning ticket for the lottery. The letter lottery logo 601 may be present at the top of the ticket 600. The scheduled date and time of the lottery drawing 603 is also present on the ticket 600. The letter-based lottery ticket 600 may also include other information including game rules, ticket serial number embedding into a QR code 605, odds of winning and lottery website 604, or any other desired information. Further, it should be appreciated that different ticket types and formats may be used depending on the theme, format and rules of the game. The letter-based lottery ticket 600 may be printed with any optically readable material such as ink or encoded with data on a magnetic material or other smart chip.

It should be noted that the lottery ticket must have the non-numeric characters which form the basis of the winning of a player. The non-numeric characters may be English characters, Japanese characters, Chinese characters, French characters, or symbols/characters of any other country. A lottery user wins the lottery game based upon whether set of characters included on the user's ticket match those of the drawn set of characters based on the rules of the individual letter-based lottery game. The letter-based lottery ticket 600 also serves as a receipt of purchase for user playing the lottery game and is generated after the user has selected their set of characters in accordance with the game rules and paid the required fee.

In a further aspect, the present invention is directed towards a method for awarding at least a portion of a jackpot amount in a lottery game to a plurality of players. The method may include dividing the jackpot amount into a base jackpot amount and a subset wager jackpot amount wherein the base jackpot amount is awarded to the player having the entire user's set of letters matching the drawn set of letters in the same order. Typically, the base jackpot amount is significantly larger than that of the subset wager jackpot amounts due to the odds of winning each type of jackpot being different.

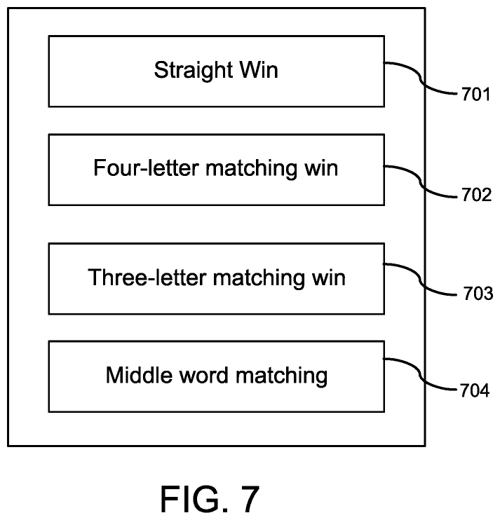

FIG. 7 illustrates a plurality of exemplary ways of winning one potential embodiment of the letter-based lottery game 100 of the present invention in accordance with the disclosed architecture. As shown, a straight win 701 provides the highest winning amount to a user and requires the user's set of letters to be matched with the winning set of drawn letters. The lottery may provide the different awards or prizes such as “Straight five award” given to a user having a ticket with all five letters in the same order as the drawn winning set of letters, which is the winning permutation in this drawing. “Straight four award” will be given to one or more users having a ticket with the first four letters in the same order as the drawn winning set of letters.

A four-letter matching win 702 takes place in the user's set of five or more letters. A match of any four letters in the same position and order as that of the set of drawn letters will also provide a level of winning. Similarly, three-letter matching win 703 takes place in game having a set of four or more letters. A middle word matching win 704 will be given to one or more user having a ticket with the middle three letters in the same order as the drawn winning set of letters.

In the present embodiment, the letter-based lottery game system of the present invention also provides different word-based games where the players can win prizes based on the four-letter words or three-letter words formed within the user's set of five letters 500. The words of the English vocabulary that may be three-letter or four-letter words may also be designated as winning tickets as determined by the rules of the novel letter-based lottery system of the present invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “non-numeric characters or letter-based lottery game”, “letter-based lottery game”, “letter-based lottery system”, and “symbols-based or letter-based lottery system” are interchangeable and refer to the letter-based lottery system 100 of the present invention.

Notwithstanding the forgoing, the letter-based lottery game 100 of the present invention can be of any suitable rules and configuration as is known in the art without affecting the overall concept of the invention, provided that it accomplishes the above stated objectives. One of ordinary skill in the art will appreciate that the rules, configuration and method of playing non-numeric characters or letter-based lottery game 100 as shown in the FIGS. are for illustrative purposes only, and that many other types of letter patterns, lottery tickets and rules within the letter-based lottery system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of conducting a lottery comprising the steps of:
offering for sale to a customer a plurality of lottery tickets, wherein each of the plurality of lottery tickets comprises a plurality of letters;
generating randomly a predetermined number of letters; and
issuing a payout to the customer.

2. The method of conducting a lottery as recited in claim 1, wherein the plurality of letters is three.

3. The method of conducting a lottery as recited in claim 1, wherein the plurality of letters is four.

4. The method of conducting a lottery as recited in claim 1, wherein the plurality of letters is five.

5. The method of conducting a lottery as recited in claim 1, wherein the plurality of letters is six.

6. The method of conducting a lottery as recited in claim 1, wherein the plurality of letters are randomly generated.

7. The method of conducting a lottery as recited in claim 1, wherein the plurality of letters are selected by the customer.

8. The method of conducting a lottery as recited in claim 1, wherein a size of the payout is dependent on a number of matches between the plurality of letters and the randomly generated number of letters.

9. The method of conducting a lottery as recited in claim 8, wherein the size of the payout increases as the number of matches increases.

10. The method of conducting a lottery as recited in claim 1, wherein a size of the payout is dependent on an order of the randomly generated number of letters.

11. The method of conducting a lottery as recited in claim 1 further comprising a step of generating randomly a wildcard letter.

12. The method of conducting a lottery as recited in claim 11, wherein the wildcard letter is considered a match of a select one of the plurality of letters.

13. The method of conducting a lottery as recited in claim 1 further comprising a step of dividing a jackpot amongst at least two winners.

14. The method of conducting a lottery as recited in claim 1 further comprising a step of comparing the plurality of letters to the randomly generated number of letters.

15. The method of conducting a lottery as recited in claim 14 further comprising a step of calculating a number of matches from the comparison, wherein a size of the payout is determined by the number of matches.

16. The method of conducting a lottery as recited in claim 15, wherein the size of the payout increases as the number of matches increases.

17. The method of conducting a lottery as recited in claim 16, wherein each of the plurality of letters and the predetermined number of letters are in a language other than English.

18. A lottery system comprising:
a plurality of lottery tickets;
a plurality of alphabet letters that may be randomly or selectively chosen by a customer and printed on the plurality of lottery tickets;
a system for randomly selecting a predetermined number of the plurality of alphabet letters; and
a device for comparing the plurality of alphabet letters randomly or selectively chosen by the customer to the randomly selected plurality of alphabet letters to identify a match.

19. The lottery system as recited in claim 18, wherein the plurality of alphabet letters are chosen from a pool of letters in the English alphabet.

20. A lottery system comprising:
a plurality of lottery tickets;
a plurality of non-numeric characters that may be randomly or selectively chosen by a customer and printed on the plurality of lottery tickets;
a system for randomly selecting a predetermined number of the plurality of non-numeric characters; and
a device for comparing the plurality of non-numeric characters randomly or selectively chosen by the customer to the randomly selected plurality of non-numeric characters to identify a match.
